(19) United States
(12) Patent Application Publication
(10) Pub. No.: US 2017/0197239 A1
(43) Pub. Date: Jul. 13, 2017

(54) MULTIPLE BROACHING MARKS ON RULES

(71) Applicant: SEOUL LASER DIEBOARD SYSTEM CO., LTD., San Diego, CA (US)

(72) Inventor: Kyong Chan Lim, San Diego, CA (US)

(21) Appl. No.: 15/472,045

(22) Filed: Mar. 28, 2017

Related U.S. Application Data
(63) Continuation-in-part of application No. 14/692,591, filed on Apr. 21, 2015.
Application No. 14/692,591 is a continuation-in-part of application No. 13/458,883, filed on Apr. 27, 2012, now Pat. No. 9,126,252.
Application No. 13/458,883 is a continuation-in-part of application No. 13/133,133, filed on Jan. 10, 2012, now abandoned.
(60) Provisional application No. 62/314,233, filed on Mar. 28, 2016.

(51) Int. Cl. B21D 11/22; G09F 7/16; B23D 37/00

(52) U.S. Cl. CPC B21D 11/22; B23D 37/00; G09F 7/16

(57) ABSTRACT

Methods and apparatus for making multiple broaching marks on the rules.

### CROSS-REFERENCE TO RELATED APPLICATIONS

This application is a continuation-in-part of U.S. patent application Ser. No. 14/692,591, filed Apr. 21, 2015, which is a continuation-in-part application of U.S. patent application Ser. No. 13/458,883, filed Apr. 27, 2012, which is a continuation-in-part application of U.S. patent application Ser. No. 13/133,133, filed Jan. 10, 2012. This application also claims the benefit of priority under 35 U.S.C. §119(e) of co-pending U.S. Provisional Patent Application No. 62/314,233, filed Mar. 28, 2016, entitled “Multiple Broaching Marks on Rules.” The disclosures of the above-referenced applications are incorporated herein by reference.

### BACKGROUND

Technological Field

The present disclosure relates to rules, and more specifically, to making multiple broaching marks on the rules.

Related Art

As shown in FIG. 1A, a strip of metallic material 100 (sometimes referred to as “rule”) may be partially cut with a broaching mark 110 along the direction that is perpendicular to the feeding direction 120 of the strip 100 to enable the strip 100 to be folded along the line cut with the broaching mark 110. For example, the broaching mark 110 may partially cut into the surface of the strip 100 (e.g., 50% of the thickness 130 of the strip) in a V-shape. Examples of making of broaching marks on a rule or profile are shown in U.S. Pat. No. 9,126,252 (which is assigned to the same assignee as the assignee of the current application).

FIG. 1B shows a top view of the strip 100 with the broaching mark 110. However, when the strip 100 is bent along the broaching mark 110 into a small angle, the strip 100 may bulge, which may cause the strip 100 to be damaged.

### SUMMARY

In general, this disclosure describes apparatus and methods for making multiple broaching marks on the rules.

One aspect of the present disclosure provides a method for making multiple broaching marks on the rules.

Another aspect of the present disclosure provides an apparatus for making multiple broaching marks on the rules.

Other features and advantages of the present disclosure should be apparent from the following description which illustrates, by way of example, aspects of the disclosure.

### BRIEF DESCRIPTION OF THE DRAWINGS

The details of the present disclosure, both as to its structure and operation, may be gleaned in part by study of the accompanying drawings.

FIG. 1A is a side view of a strip of metallic material partially cut with a broaching mark along the direction that is perpendicular to the feeding direction of the strip;

FIG. 1B is a top view of the strip of metallic material with the broaching mark;

FIG. 2A shows the rule bent into a channel letter shape;

FIG. 2B shows the completed channel letter (e.g., letter “K”);

FIG. 3A shows a strip of rule;

FIG. 3B shows one side surface of a strip of profile;

FIG. 3C shows the other side surface (e.g., inside surface) of the strip of profile;

FIG. 3D shows a roll of rule with two side surfaces;

FIG. 4A shows the rule with the broaching mark bent to angle x;

FIG. 4B shows the rule bent to angle y, which is smaller than angle x;

FIGS. 5A through 5C show multiple broaching marks (e.g., marks x, y, z) made on the rule to enable the rule to be folded to a relatively small angle (e.g., angle q) without causing bulges on the rule; and

FIG. 6 shows a side view of a rule bent to a small angle without causing any bulges on the rule.

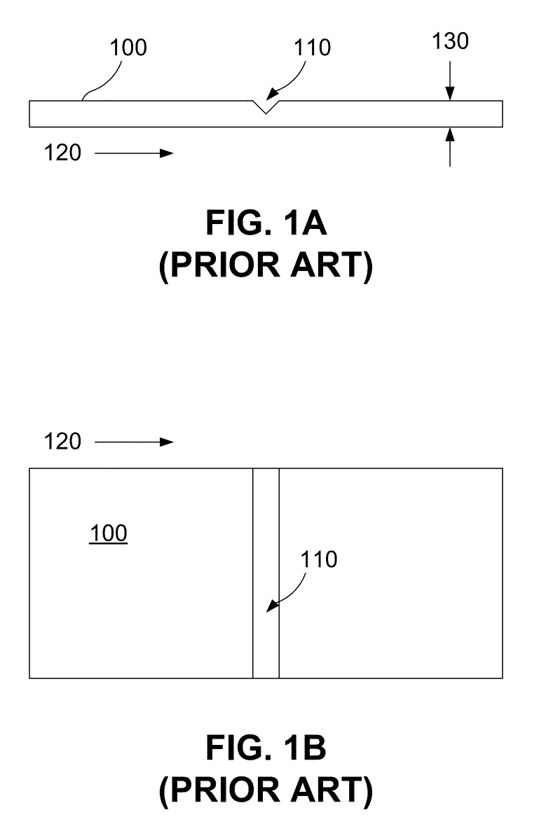

### DETAILED DESCRIPTION

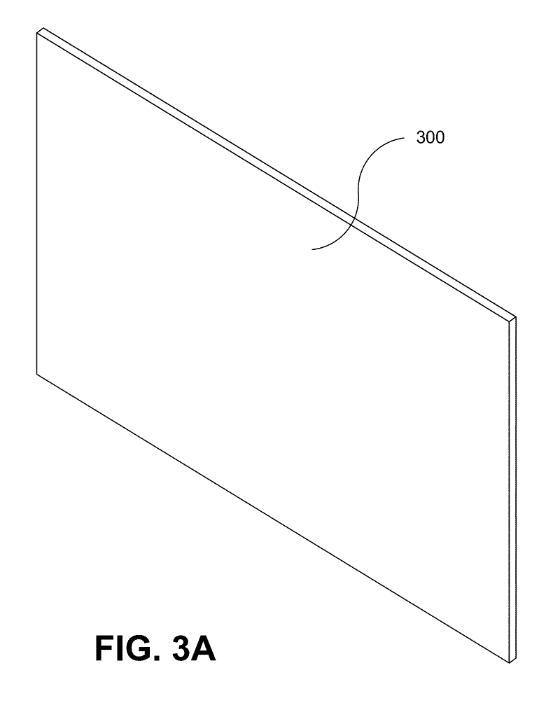

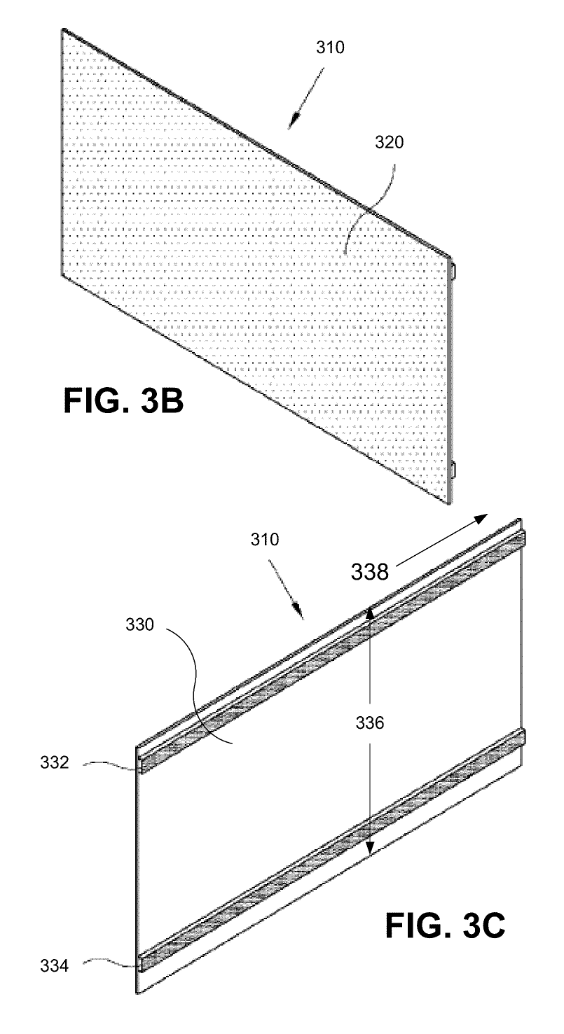

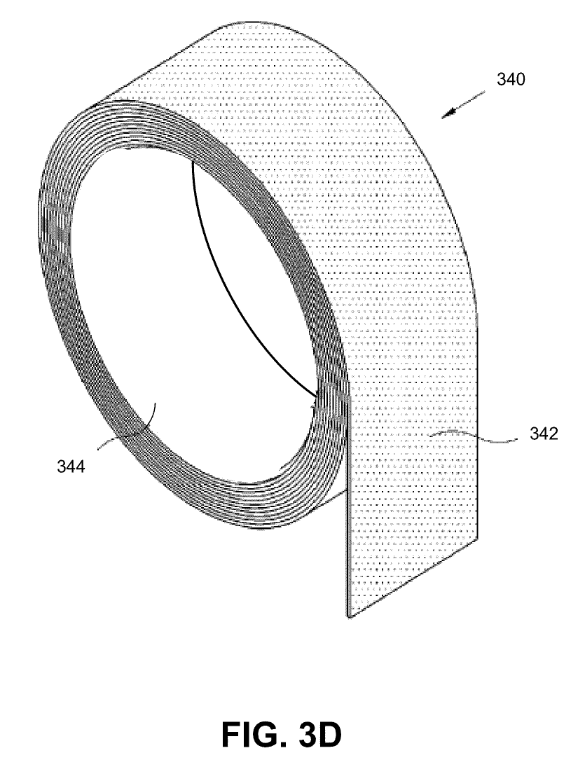

As described above, when a strip of material (sometimes referred to as “rule”) is bent along a broaching mark into a small angle, the strip may bulge, which may cause the strip to be damaged. Certain embodiments of the present disclosure provide an alternative solution which significantly reduces the bulge and prevents damage. In one embodiment, the alternative solution includes apparatus and methods for making multiple broaching marks on the rule or profile in which bending of the rule along the broaching mark is made easier. In one embodiment, a rule, for the purposes of this application, is a strip of material used to form a channel letter. A profile may refer to a rule with rib(s) attached to it (e.g., elements 332, 334 of FIG. 3C). In general, the rule or profile may be interchangeably used.

After reading these descriptions, it will become apparent how to implement the disclosure in various implementations and applications. However, although various implementations of the present disclosure will be described herein, it is understood that these implementations are presented by way of example only, and not limitation. As such, this detailed description of various implementations should not be construed to limit the scope or breadth of the present disclosure.

The detailed description set forth below, in connection with the accompanying drawings, is intended as a description of various embodiments and is not intended to represent the only embodiments in which the disclosure may be practiced. The detailed description includes specific details for the purpose of providing a thorough understanding of the embodiments. In some instances, well-known structures and components are shown in simplified form for brevity of description. As used herein, like reference numerals refer to like features throughout the written description.

In one embodiment, multiple broaching marks are made on a relatively thick rule (e.g., a rule with a thickness greater than 1.0-1.6 millimeters). In another embodiment, multiple broaching marks are made even on a relatively thin rule (e.g., a rule with thickness less than 1.0 millimeters) when the rule is made of material that is strong (e.g., stainless steel) such that it is difficult to bend.

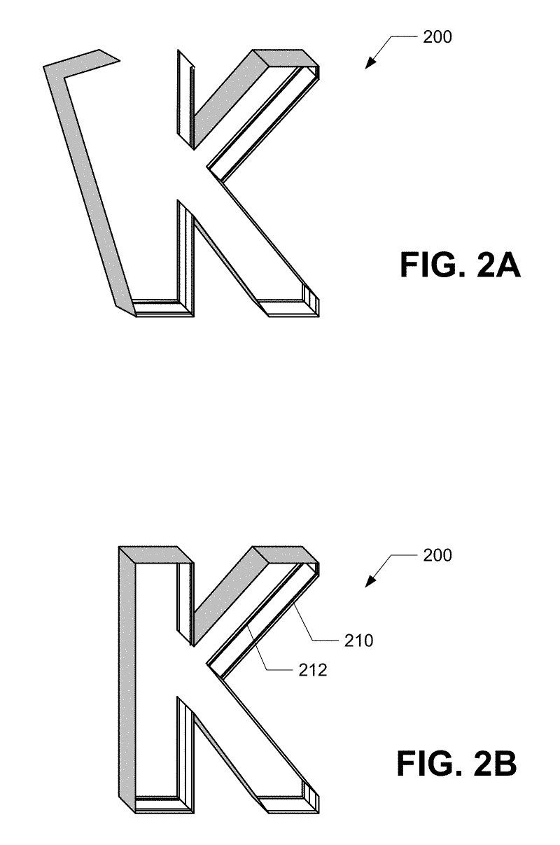

FIGS. 2A and 2B show a channel letter box 200 made with a profile in accordance with one embodiment of the present disclosure. FIG. 2A shows the rule bent into a channel letter shape. FIG. 2B shows the completed channel letter (e.g., letter “K”). As can be seen in FIG. 2B, for example, the channel letter box 200 includes a top rib 210 for retaining the top plate and a bottom rib 212 for fitting into a bottom plate.

In one embodiment, the rules can be made into strips or rolls. FIG. 3A shows a strip of rule 300. FIG. 3B shows one side surface 320 of a strip of profile 310. FIG. 3C shows the other side surface 330 of the strip of profile 310. The other side surface 330 may include ribs 332, 334 to support the top and bottom covers of a channel letter. Thus, in one embodiment, a profile can be formed using a rule with at least one strip of rib attached to one surface of the rule. FIG. 3D shows a roll of rule 340 with two side surfaces 342, 344. The roll 340 can also be made as a roll of profile with a side surface (e.g., a surface 344) including ribs to support the top and bottom covers of a channel letter.

In some embodiments, the profile 310 can have a first surface 330 shown in FIG. 3C. The first surface 330 may also be referred to herein as the “inside surface,” indicating that the first surface 330 may generally become the inside of a resulting channel letter once the profile 310 has been cut and folded. The profile 310 (or the rule 300) can generally have a profile height 336 on the order of a few centimeters (cm), for example, one or two cm to in excess of 20 cm. The profile height 336 can also describe the height of the first surface 330. The profile 310 may also be many meters long (in the direction of the profile axis 338). As shown in FIG. 3D, the profile 310 (and the rule 300) can be stored in large rolls from which certain portions or lengths can be cut, for example, to produce the portion of the profile 310 shown. Lengths or sections of the profile 310, can be cut from the roll and then fed into a profile cutting and bending machine (not shown) to make a variety of channel letters or shapes from the profile 310.

In some embodiments, the rule 310 can be formed of a suitable metallic material, such as aluminum, steel, stainless steel, or various other alloys that provide a malleable, yet sturdy construction. The rule 310 may further have a protective coating to prevent corrosion or oxidation and to provide a suitable mounting surface for the ribs 332, 334. Such a protective coating can be applied at least to the first surface 330, but can also be applied to an outside surface 320. The outside surface 320 is opposite the first surface 330 and may generally become the outside of the resulting channel letter once the profile 310 is cut and folded.

In certain embodiments, such a protective coating may be an enamel coating. In some other embodiments, the profile 310 can be coated with certain types of powder coating, lacquer, or paint applied to the entire rule 300. In some embodiments, coating the rule 300 in enamel can have certain chemical advantages for adhering or bonding of the ribs 332, 334. The coating can further have desirable artistic or design characteristics provided by different colored coatings having various reflective or textured properties. For example, a white first surface 330 may have desirable reflective properties for light emitted from within a completed channel letter. The colors and coatings of the first surface 330 can be different from the colors and coatings of the outside surface.

As described above, the profile 310 can further have the ribs 332, 334. In some embodiments, the ribs 332, 334 can be attached, bonded, or otherwise adhered to the first surface 310 of the profile 310. In some embodiments, the ribs 332, 334 can be formed of a polymer, elastomer, plastic, fiber-reinforced plastic (FRP), or other suitable synthetic materials. In some other embodiments, the rib 332, 334 can be attached using a machine that applies or adheres the ribs 332, 334 in place on a blank surface 330 of the profile 310.

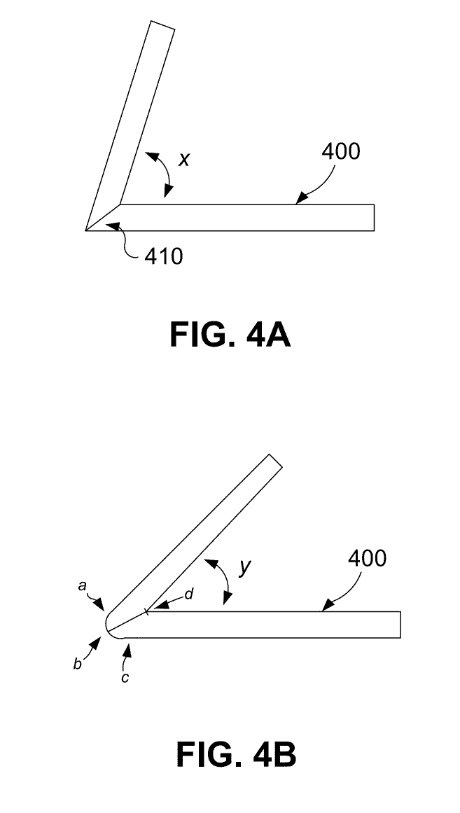

FIGS. 4A and 4B show the process of folding the broaching mark 410 made on a rule 400. In one embodiment, the rule 400 can be bent or folded using a channel bending machine (which is extensively described in U.S. Pat. Nos. 7,441,434, 7,878,039, 8,327,679, for example, and which are all assigned to the same assignee as the assignee of the current application).

FIG. 4A shows the rule 400 with the broaching mark 410 bent to angle X in accordance with one embodiment of the present disclosure. Thus, in the illustrated embodiment of FIG. 4A, the profile 400 is folded along the broaching mark 410. FIG. 4B shows the rule 400 bent to angle y, which is smaller than angle x shown in FIG. 4A. However, as the rule 400 is bent to a relatively small angle (e.g., angle y which is smaller than angle x), the rule 400 starts to bulge (e.g., at points a, b, c, d) and may cause the rule 400 to be damaged. Although the angle of the broaching mark (e.g., mark 410 in FIG. 4A) can be increased so that the rule 400 can be folded to angles as small or smaller than angle y, there are several factors which does not make increasing the angle of the broaching mark easy. Firstly, apparatus that is making the broaching mark needs to be adjustable to adjust the broaching mark angle. Secondly, it is not easy to manufacture instrument(s) that can make a large broaching mark angle. Thirdly, a large broaching mark angle may cause the rule 400 to be weakened such that it breaks.

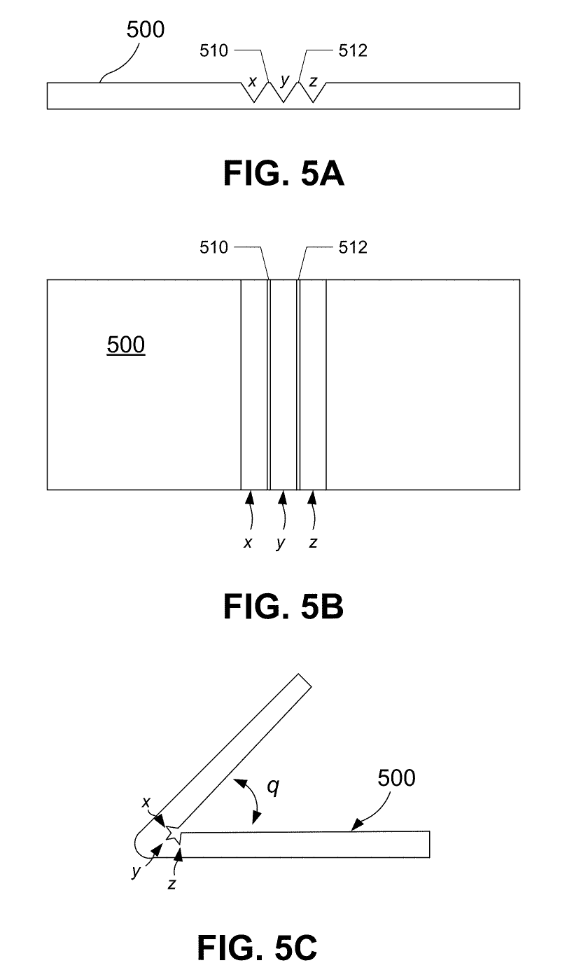

Accordingly, FIGS. 5A through 5C show multiple broaching marks (e.g., broaching marks x, y, z) made on the rule 500 to enable the rule 500 to be folded to a relatively small angle (e.g., angle q) without causing bulges on the rule 500. In the illustrated embodiment of FIGS. 5A through 5C, three broaching marks (x, y, z) are made so that the rule 500 can be folded to angle q. FIG. 5C shows the rule 500 having three broaching marks (cut into a star-shaped mark) bent to angle q without causing any bulges on the profile 500. Although only three broaching marks are shown in FIGS. 5A to 5C, any number of broaching marks greater than one can be used. Although FIGS. 5A through 5C show bending of the rule, same techniques can be applied to bending of the profile.

In one embodiment, the broaching marks x, y, z can be cut and configured in a variety of different ways to provide the rule 500 with a bend having an appropriate angle that allows bending of the rule 500 without any bulge. For example, in one embodiment, the broaching marks can be cut in U-shapes rather than V-shapes. In another example, spaces (e.g., 510, 512) are left between the cuts x, y, z to allow smooth bending of the rule 500.

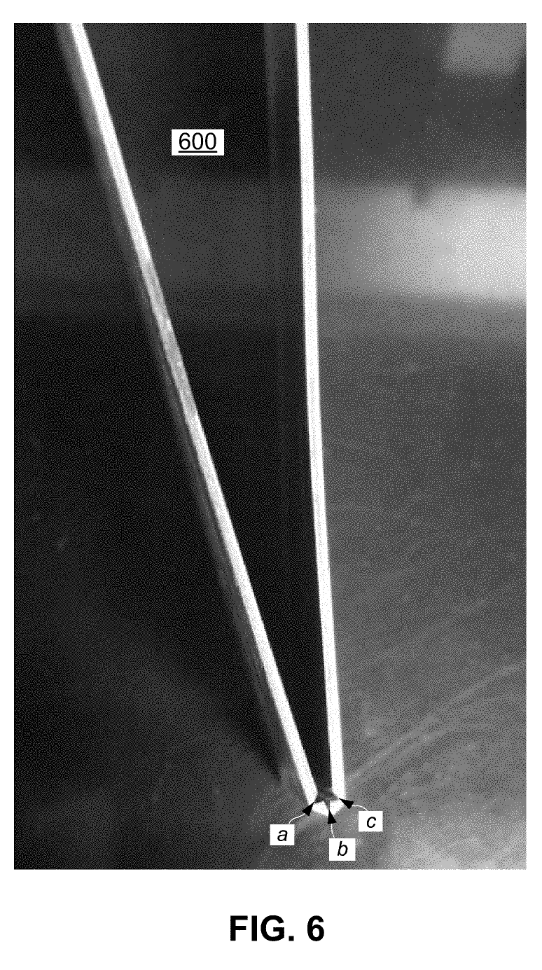

FIG. 6 shows a side view of a rule 600 bent to a small angle without causing any bulges on the rule.

The above descriptions of the disclosed embodiments are provided to enable any person skilled in the art to make or use the disclosure. Various modifications to these embodiments will be readily apparent to those skilled in the art, and the generic principles described herein can be applied to other embodiments without departing from the spirit or scope of the disclosure. Thus, it will be understood that the description and drawings presented herein represent embodiments of the disclosure and are therefore representative of the subject matter which is broadly contemplated by the present disclosure. It will be further understood that the scope of the present disclosure fully encompasses other embodiments that may become obvious to those skilled in the art and that the scope of the present disclosure is accordingly limited by nothing other than the appended claims.

Accordingly, the foregoing embodiments are merely presented as examples and are not to be construed as limiting the present disclosure. The present teachings can be readily applied to other types of apparatus and/or devices. The description of the present disclosure is intended to be illustrative, and not to limit the scope of the claims. Many alternatives, modifications, and variations will be apparent to those skilled in the art.

What is claimed is:

1. A method for making multiple broaching marks on the rules, the method comprising:
a first process as described above; and
a second process as described above.

2. An apparatus for making multiple broaching marks on the rules, the apparatus comprising:
a first element as described above; and
a second element as described above.
